(19) United States
(12) Patent Application Publication
(10) Pub. No.: US 2020/0084039 A1
(43) Pub. Date: Mar. 12, 2020

(54) METHOD AND SYSTEM FOR ELECTRONIC VOTING WITH BIOMETRIC IDENTIFICATION

(71) Applicant: Idemia Identity & Security France, Courbevoie (FR)

(72) Inventors: Hervé CHABANNE, Courbevoie (FR); Emmanuelle DOTTAX, Courbevoie (FR)

(21) Appl. No.: 16/568,832

(22) Filed: Sep. 12, 2019

(30) Foreign Application Priority Data
Sep. 12, 2018 (FR) 1858179

(51) Int. Cl. H04L 9/32; G07C 13/00; G06F 21/12; G06F 12/0817

(52) U.S. Cl. CPC H04L 9/3231; G07C 13/00; G06Q 50/26; G06F 12/0826; G06F 21/123

(57) ABSTRACT

The invention concerns a voter enrollment method implemented from a plurality of biometric data acquired on several voters, the method comprising the steps of receiving biometric data and associating each biometric data with at least one voting cryptographic data or a pointer, so that subsequently, during a poll, each voter can be biometrically identified using the electronic device and vote with his cryptographic voting data.

The invention also concerns an electronic voting method comprising the steps of receiving biometric data acquired by a biometric sensor on an individual, said biometric data corresponding to a type of biometric data used for enrollment, verifying a match between the acquired biometric data and a stored biometric data, and, if said verification is positive, transmitting a voting result generated using a voting cryptographic data.

### CROSS-REFERENCE TO RELATED APPLICATIONS

This application claims the benefit of French Patent Application No. 1858179 filed Sep. 12, 2018, the disclosure of which is herein incorporated by reference in its entirety.

### TECHNICAL FIELD OF THE INVENTION

This invention is in the field of secure electronic voting. In particular, this invention concerns a method for enrollment prior to an election, including the loading of smart cards for biometric identification of voters, as well as a voting method using the smart cards.

### STATE OF THE ART

To facilitate and make voting operations more reliable during an election, several States and local authorities have already adopted electronic voting protocols and have set themselves free from paper ballots.

Two fundamental properties of an electronic voting method are the confidentiality and the verifiability of the ballots: the ability for a third party to verify that the final result of the vote corresponds to the votes cast by voters.

To ensure confidentiality, it is known that encryption of the voting options expressed by voters is used, while only a certified server holds the decryption key that validates a voting option. Some types of encryption allow an administration server to determine a final voting result without having access to each individual vote in decrypted form.

With regard to verifiability, the use of private key signature algorithms, when votes are sent, ensures that only previously authorized voters participated in the vote.

To enhance elections' security, it is known that a password is required from each voter when casting their votes. As such, a known system is based on the provision of a smart card to each voter during the enrollment method prior to the election. The voter must therefore bring his or her card to participate in the vote.

On the smart card, a private key is registered that allows the voter to be identified as a unique voter. The use of a smart card is advantageous since it is a support that can easily be audited to prove the integrity and security of the algorithms encoded on it.

The publication, Receipt-free electronic voting scheme with a tamper-resistant randomizer, Lee, Kim, in: Information Security and Cryptology—ICISC 2002, Revised Papers, pp. 389-406 (2002), describes smart cards wherein voter private keys are encoded and equipped with random generators to perform encryption of a voting option.

The publication Receipt-freeness in large-scale elections without untappable channels, Magkos, Chrissikopoulos, In: Towards the E-Society: E-Commerce, E-Business, and E-Government, 13E, n pp. 683-693 (2001) also describes a voting protocol with voter private key encoding on a smart card.

However, it is not feasible to provide each voter with a smart card containing a unique private key.

A major constraint is the cost of such a deployment, since it is necessary to provide for a number of smart cards equal to the number of authorized voters. In addition, the cards are not easily retrievable for subsequent ballots since each authorized voter keeps a card in their possession.

Another disadvantage is the possibility for an authorized voter to give his or her smart card to individuals who are not authorized voters and to provide them with a password to unlock access to the card data, which would allow them to participate in the voting.

### GENERAL DESCRIPTION OF THE INVENTION

In view of the above, there is a need for an enrollment and voting method that is much less costly for States and communities.

However, the reduction in the cost of registration must be achieved without compromising the security of the elections, particularly with regard to the fundamental verifiability of votes.

This invention concerns, in this respect, according to a first aspect, an enrollment method in accordance with claim 1.

The recording, in the electronic device, of an association between a plurality of biometric data and cryptographic voting data allows to store the cryptographic data on an electronic device that can be later used by several voters. Subsequent biometric identification during voting ensures that the right person will use the right cryptographic data.

This enrollment method therefore has the advantage of being less expensive than previously known enrollment techniques, as it is no longer necessary to provide a large number of devices—such as smart cards—at the ratio of one device per voter to be enrolled.

The security of private key storage is also enhanced since the electronic device is configured to allow the use of voting cryptographic data only if a biometric identification is successful.

An additional advantage is that an authorized voter is not required to learn or retain a password or identifier. The identification, in order to participate in the election, is biometric. This type of identification is quick and convenient for the voter.

The above mentioned enrollment method may include the following optional and non-restrictive characteristics, taken alone or in any of their technically possible combinations:
each of the biometric data is associated with voting cryptographic data of a single voter in the memory;
the method includes an additional step of generating the voting cryptographic data by the electronic device;
the method includes a receipt of the voting cryptographic data;
the biometric data is associated in the memory with a pointer corresponding to the voting cryptographic data and said cryptographic data is stored in a remote database;
the voting cryptographic data include a secret voter's key usk_{id} and a public voter's key upk_{id}, preferably in the form, upk_{id}=g^{uskid} mod p with p and g domain parameters;
the method comprises a prior step of association, in a remote server database, between a voter identifier from the plurality of voters and a polling station identifier, the biometric data being transmitted only to an electronic device intended to be in a polling station corresponding to said polling station identifier during the poll.

The invention also concerns a voting method in accordance with claim 8.

The voting method may particularly be implemented following an enrollment method as defined above.

The voting method may include the following non-exhaustive characteristics, taken alone or in any of their technically possible combinations:
the method includes additional steps of entering an voting option per the user and encrypting the voting option using a voting key to obtain an encrypted vote included in the voting result;
the encryption step further includes generating a proof of voting validity using the cryptographic data, preferably using a secret voter key included in the cryptographic data;
the method includes an additional signing step by the individual, of the encrypted vote using the cryptographic data, preferably using a secret voter key included in the cryptographic data, to obtain a signed vote included in the voting result;
to generate the voting result, the electronic device transmits to a remote server a pointer corresponding to a voting cryptographic data, and receives the cryptographic data from the remote server;
the cryptographic data being preferably encrypted with an encryption key (e) of the electronic device;
the verification includes a calculation of the Euclidean or Hamming distance between the acquired biometric data and the stored biometric data;
the verification step includes searching for a match between the biometric data acquired by the sensor and the plurality of biometric data stored during enrollment, preferably by a “Nearest Neighbour Search” method;
the method includes a subsequent analysis step including a calculation of a voting result from encrypted votes associated with signed votes having a valid signature;
in the latter case, the analysis includes a calculation of the voting result from the encrypted voting options and using homomorphic properties of the voting encryption system;
the method includes steps of receiving voting results by an administration server and calculating a total result including checking the voting results against proof of correct counting.

The invention concerns, in another respect, an electronic device according to claim 13.

The electronic device may also, but not exclusively, be configured to encrypt a voting option submitted by an individual using a voting key pre-registered in the electronic card and/or to generate a signed vote using the voting cryptographic data.

The electronic device may be, but is not limited to, a smart card or USB key or a secure mobile device.

The invention relates, in another aspect, to a voting device intended to be installed in a polling station, the voting device comprising such an electronic device, a biometric sensor and a voting terminal comprising a user interface.

### GENERAL DESCRIPTION OF THE FIGURES

Other characteristics, goals, and advantages of the invention will become clear from the following description, which is purely illustrative and non-limiting, accompanied by the attached drawings in which:

FIG. 1 schematically represents an example of an electronic voting system of the invention;

FIG. 2 schematically represents a voting device according to an embodiment, intended for use in a polling station;

FIG. 3A illustrates the steps of an enrollment method according to a first embodiment;

FIG. 3B illustrates the steps of an enrollment method according to a second embodiment;

FIG. 4 illustrates the steps of an electronic voting method according to a possible embodiment wherein the cryptographic voting data include, for a previously enrolled voter, a private key and a public key.

### DETAILED DESCRIPTION OF EMBODIMENTS

Thereafter, the use of smart cards to submit an electronic vote during an election is described. However, the registration for the vote, as well as the electronic voting itself, could be carried out with an electronic device other than a smart card, provided that the said device includes a secure element.

“Secure element” means a platform with a secure processor configured to provide tamper-proof storage of data using secure keys. The processor is further configured here to perform calculations, including comparisons between acquired biometric data and biometric data stored in memory. Such a secure element is easily auditable by a trusted authority. A SIM card, an eSE card, a micro-SD card are examples of such secure elements.

The presentation, Mobile/NFC Security Fundamentals, Smart Card Alliance, available at the following URL address: https://www.securetechalliance.org/resources/webinars/Secure_Elements_1 01_FINAL3_032813.pdf, describes, in particular on pages 6 to 9, examples of secure elements and a potential electronic card architecture constituting a secure element.

In addition, the following description concerns a vote at an official polling station in a territory (State or local community). The invention applies with the same advantages in any other type of election, or in a context other than an election requiring several individuals to communicate data of their choice in an authenticating manner, for example as part of a knowledge test.

It is then not necessary for the data communicated to be encrypted.

On the attached figures and in the description below, similar elements are designated by the same alphanumeric reference.

### Electronic Voting System

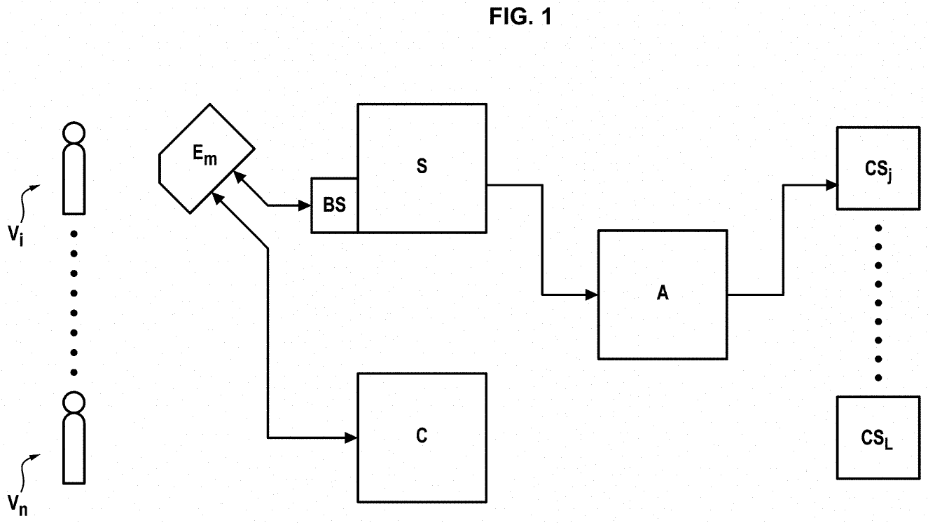

FIG. 1 shows a functional architecture of an electronic voting system based on an example, allowing voters V₁, . . . , Vᵢ, . . . , Vₙ to participate in a vote. The voting system includes an enrollment server C and at least one, preferably several, voting devices each including a voting terminal S, biometric sensor BS and a smart card Eₘ.

Preferably, the voting system also includes a voting administration server A and a plurality of certification servers CS₁, . . . , CSⱼ, . . . , CSₗ.

The enrollment server C includes a memory to store biometric data acquired in a certified manner, or alternatively, has access to a certified biometric data database.

In a possible variant, Server C is configured to generate cryptographic voting data and to transmit said data to a smart card Eₘ. To this end, the server can be equipped with a card reading interface.

Server A is connected to the servers CSⱼ and the voting terminal S via a high-security communication network. Data exchanges between said entities preferably are encrypted.

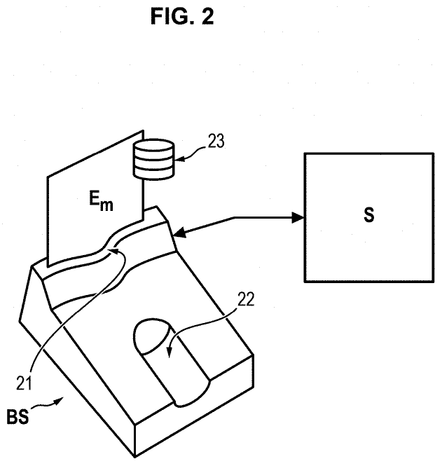

FIG. 2 illustrates a voting device according to an example, including the voting terminal S, the smart card Eₘ and the biometric sensor BS. Throughout the following, we will refer indifferently to “electronic card” or “smart card”.

The voting device in FIG. 2, for example, is made available to authorized voters during a poll in a polling station voting booth. The confidentiality of the vote is guaranteed by the fact that the voting booth can only admit one person at a time.

The sensor BS includes a slot 21 for inserting the smart card Eₘ. The slot includes an electronic link to allow data exchange between the card and the sensor. Preferably, the data thus exchanged shall not be communicated to Terminal S.

The sensor BS further includes a biometric acquisition zone 22; in this example, fingerprints are used as biometrics and zone 22 is a finger positioning zone. The sensor BS is preferably configured to perform a liveness detection when acquiring biometric data, in order to detect potential identity theft during acquisition.

The smart card Eₘ includes computing means configured to implement the enrollment and electronic voting methods described below. The smart card further includes a memory 23 on which are stored a plurality of associations between voters' cryptographic data CD and a certified biometric data t, for example as pairs (CD, t). Cryptographic data are, for example, pairs containing a private key and a public key. The generation of the public and the private key does not necessarily imply an authority of a PKI-type infrastructure.

The calculation means and the memory are included in a secure element.

The calculation means are configured in particular to acquire biometric data b from an acquisition interface of the sensor BS and to verify a correspondence between the acquired data b and one of the data t present in the memory 23.

The smart card may also have an encryption key e that allows it to encrypt data exchanged with external entities. Encryption may be symmetric or asymmetric.

Voting terminal S has a user interface with a screen, with which a voter can view proposed voting options and select one or more voting options. The interface can be touch or button based.

Preferably, Terminal S is configured to automatically detect an attempted sabotage by an external attacker.

Optionally, the voting device can also be equipped with a printer connected to terminal S, configured to print a ballot identifier in the form of a character string, barcode or QR Code. The printed identifier is retrieved by an individual after submitting his ballot.

It should be noted that each voting device preferably contains a single smart card Eₘ to reduce the cost of deploying the voting system. In addition, the memory of each smart card Eₘ can be emptied and reused after each vote.

Thus, the cost of deploying the voting devices necessary for an election, organized for example by the State or by local communities, is significantly lower than previously known solutions based on providing an individual smart card to each authorized voter.

### Enrollment of Authorized Voters

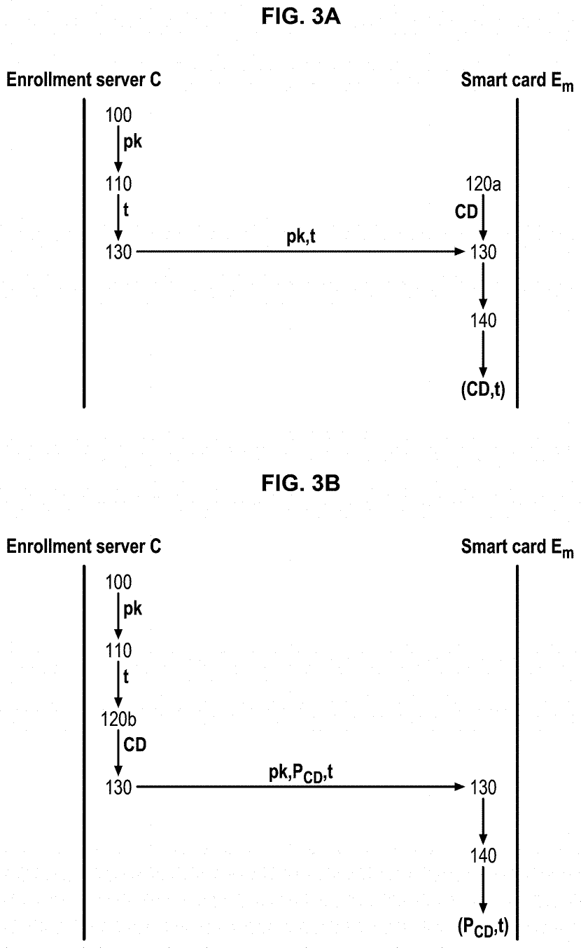

FIG. 3A shows a method for enrolling authorized voters prior to an election, according to a first embodiment. This method is implemented, for example, by an enrollment server C and an electronic card Eₘ illustrated in FIG. 1.

At an optional step 100, a voting key pk is obtained. In one possible example, the public voting key pk is generated by administration server A in connection with the certification servers CSⱼ, each certification server generating part of the voting key and the administration server calculating the public key pk.

In this example, the public voting key pk then corresponds to a plurality of secret voting keys skⱼ, each certification server CSⱼ holding one of said secret keys.

In addition, an encryption T is obtained by the card, preferably a homomorphic encryption allowing to decrypt the total number of votes without having access to each individual vote in decrypted form. If encryption T is homomorphic by addition, it checks the following equality for voting options vk:

T(v₁+ . . . +v_{N})=T(v₁)+ . . . T(v_{N})

The enrollment continues with a step 110 of acquisition, by the enrollment server C, of a biometric data in a certified way. “Certified acquisition” means that the data acquired can be reliably associated with the individual (preferably, the individual is asked to provide an official identity document at the time of acquisition). Biometric data may notably be a fingerprint and/or an iris image and/or a face image. Alternatively, any biometrics that can be eventually acquired at the time of voting can be used with sufficient speed and reliability.

As an alternative to step 110, a pre-stored biometric data t is retrieved from a database by the enrollment server.

Enrollment then includes a step 120a of generating by the card at least one cryptographic data CD associated with the voter. Alternatively, step 120a is implemented in parallel with steps 100 and 110 or before steps 100 and 110.

The cryptographic data CD is a data that allows to perform a cryptographic operation on a voting data: encryption, signature . . . . Here, the CD data corresponds uniquely to the voter.

In the following example, a voter's voting cryptographic data CD, combined with an identifier id uniquely corresponding to the voter, is a private key usk_{id} and a public key upk_{id} that allows a voter to sign a vote. Here the keys verify the following equation:

upk_{id}=g^{uskid} mod p

where p and g are domain parameters. For an example of the shape of the domain parameters p and g, see page 15 of the following document: https://nvlpubs.nist.gov/nistpubs/FIPS/NIST.FIPS.186-4.pdf.

Alternatively, any known algorithm for generating signature keys can be used.

The secret key usk_{id} can be obtained by applying a hash function to a secret phrase or “passphrase”.

In the method of FIG. 3A, the voting cryptographic data CD is therefore generated inside the card.

Cryptographic data (e.g., a private key) may be a function of the biometric data t acquired and of a master secret, or it may be a function of a voter ID and a master secret. One advantage is to ensure that the data generated by multiple smart cards are of the same format.

At a step 130, server C transmits the voting key pk and the biometric data t, preferably in encrypted form, to the electronic card Eₘ.

The enrollment method then includes a step 140 of storing, in the memory 23 of the card, the CD data (here the private key and the public key) in association with the individual's biometric data t, for example in pair form (CD, t).

Alternatively, a data pointer P_{CD} corresponding to the cryptographic data CD is stored in the card memory instead of the cryptographic data CD. The pointer is much smaller than the size of the complete CD data. One advantage of this variant is that it saves storage space on the card. The CD data is then stored in a remote database, preferably encrypted with a key K to encrypt the card.

Advantageously, the data CD (or the associated pointer) is only saved in the smart card(s) that are intended to be in the polling station where the voter is expected, according to information from a remote database. One advantage is to limit the storage resources required on each of the smart cards.

An advantage of storing the cryptographic data CD allowing electronic voting in connection with biometric data is to secure access to the cryptographic data.

Another advantage is the ability to store multiple cryptographic data on a single smart card, while ensuring that each person using the smart card can only access their own cryptographic data.

In the present example, the public key upk_{id} can, advantageously, be published after enrollment in a list L of public keys accessible on the network.

FIG. 3B shows an enrollment method of authorized voters according to an alternative second embodiment.

In this mode, the voting cryptographic data CD is not generated inside the smart card Eₘ, but is generated by the enrollment server C at a step 120b.

Steps 100 and 110 are identical to those in FIG. 3A.

In step 120b, server C generates the cryptographic data CD (e. g., a private key and a public key according to the example described above in relation to FIG. 3A).

In step 130, server C transmits the biometric data t to the smart card. It also transmits a pointer P_{CD} corresponding to the cryptographic data CD into a relational database.

Therefore, it is not necessary to transmit the cryptographic data CD to the smart card.

Alternatively, the complete data CD is stored in the smart card memory. In this case, the data CD can be forgotten by the enrollment server C, once the enrollment is completed.

In a step 140, an association between the pointer P_{CD} and the biometric data t—or, alternatively, an association between the data CD and the biometric data t—is recorded in the memory of the smart card Eₘ. At the end of this recording, a public part of the data CD can be published.

An advantage of this second embodiment is that the computing power and the storage space of the smart card Eₘ can be reduced, since it is not necessary to size the card to generate and store complete cryptographic data.

### Electronic Voting

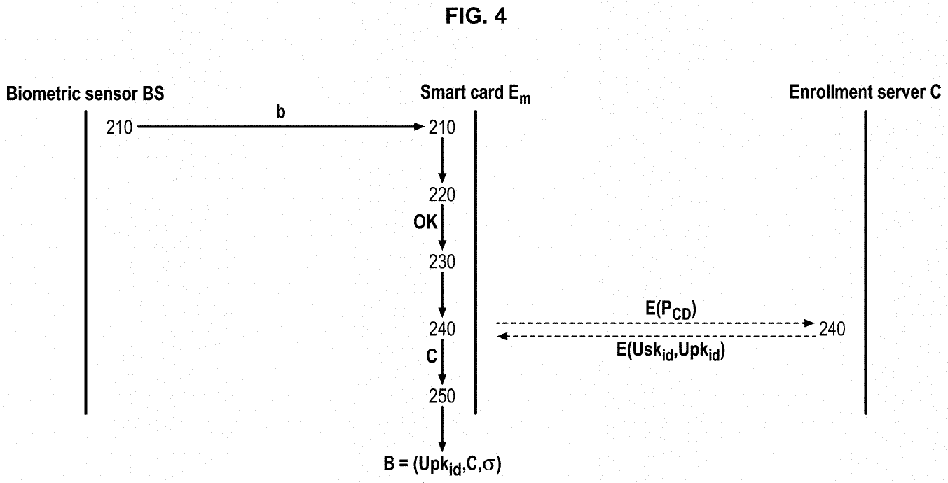

FIG. 4 illustrates an electronic voting method according to an embodiment. This method is for example implemented by the voting device described above in relation to FIG. 2, including the sensor BS and the smart card Eₘ, in relation to the enrollment server C.

During electronic voting, an individual shows at his/her corresponding polling station, the smart card Eₘ having previously been placed in a polling booth. The individual first performs biometric identification using the sensor BS and the smart card Eₘ. If the identification is successful, the associated voting cryptographic data CD can be used to submit a ballot.

In a step 210, the individual identifies him/herself by presenting on the sensor BS a type of biometric data corresponding to a biometric used for enrollment, in this case a fingerprint scanned at zone 22 of the sensor.

The sensor BS then transmits the acquired biometric data b to the card Eₘ for verification, at a step 220, of a match with one of the biometric data t stored in the card. The verification corresponds to a “Match on Card”. During identification, the individual who tries to identify him/herself is searched among N number of individuals whose biometric data are stored on the card (“1:N Match”). Alternatively, an authentication corresponding to a “1:1 Match” could be provided: the individual seeking to participate in the poll then reveals an identity, and the identity is searched in the card.

In the present example, fingerprints are used as biometric data stored as 512-bit vectors. Reference may be made to the following document: MINEX II—An assessment of Match-on-Card technology available at https://www.nist.gov/itl/iad/image-group/minex-ii-assessment-match-card-technology.

According to another example, biometric data are facial images stored on 128-bit vectors in Euclidean space. The Facenet document: A unified embedding for face recognition and clustering, Schroff, Kalenichenko, Philbin, in: IEEE Conference on Computer Vision and Pattern Recognition, CVPR. Pp 815-823 (2015) describes a possible implementation of a biometric face identification algorithm.

Biometric identification may include, in particular in the two examples above, a calculation of the distance between the acquired biometric data and a stored biometric data to verify a match between the two data. The distance used is a Euclidean distance or a Hamming distance.

Advantageously, match verification includes a Nearest Neighbour Search, the match being verified between the acquired data and the nearest neighbour.

For example, a method of searching for the nearest neighbour based on the Locality Sensitive Hashing, or LSH, is used. The document, A fast search algorithm for a large fuzzy database, Hao, Daugman, Zielinski, IEEE Trans. Information Forensics and Security 3(2), pp. 203-212 (2008), describes an LSH implementation for an identification context using individual iris images, iris data being 256-bit size vectors. Such calculations generally require less time and computing resources compared to distance calculations for all voters registered on the smart card. These calculations can therefore be easily integrated into the smart card.

To increase the security of the identification, the acquired data b is only exchanged between the smart card Eₘ and the sensor BS.

If the individual is not authenticated or identified as an authorized voter, the individual cannot use the voting terminal to submit a valid voting option.

If, on the contrary, a verification is positive, the smart card Eₘ or sensor BS sends, at a step 230, to the voting terminal an OK command to authorize the individual to submit a voting option. FIG. 4 corresponds to a positive verification.

The voter can then use a digital interface on the voting terminal S to select one of several possible voting options, for example among several candidates.

Depending on variants, it is possible to select several options in a single vote and/or to submit a blank vote.

In another variant, the biometric data required for authentication and the selected voting option are submitted to the smart card Eₘ at the same time. In this case, the voting option is taken into account if the biometric identification in the card is successful.

It may happen that an authorized voter cannot perform biometric identification with a biometric used by the biometric sensor BS if said biometric is altered in that voter. Preferably, the voting device provides for the possibility of using another type of identification, or of entering a non-electronic vote with a paper ballot.

In the present example, electronic voting verifies confidentiality and verifiability properties. Here, the voting option selected by the voter is encrypted and the encrypted vote is signed, resulting in a complete and secure ballot B.

Optionally, the cryptographic data CD required for encryption and signature is not stored on the card but in a remote database, for example in the enrollment server C. The smart card Eₘ then communicates to server C the associated pointer P_{CD} in the card memory with the biometric data that was recognized during identification. The card then retrieves from server C the encrypted CD data with the card's encryption key K.

Here, the card retrieves the private key uskid. The key upk_{id} is public.

Then, at a step 240, a voting option v selected by the voter is encrypted using the voting key pk, resulting in an encrypted vote c.

The voting option is here further encrypted using homomorphic encryption T.

In this example, the encryption of the vote is performed according to an El Gamal encryption algorithm. A new random integer r is generated each time a new voting option is encrypted, preferably by a smart card Eₘ random generator, and the encrypted vote is generated based on the voting option v and the public voting key pk.

For example, the encrypted vote is in the form c=(α,β) where β depends on the voting option and the public key pk and a depends on the integer r.

The number α may have been pre-calculated before the encryption, since it does not depend on the selected voting option. This number can be retrieved at step 240 in encrypted form from a database.

Advantageously, encryption 240 further includes the generation of proof of voting validity associated with encrypted voting. This is proof that the voting option and encrypted voting are well formed.

See section 4.8 of the Belenios specification document: http://www.belenios.org/specification.pdf for an example of how to calculate an encrypted vote based on the voting key and how to prove the validity of a vote based on a private key (“credential”).

The voter can only generate proof of voting validity if he or she has cryptographic voting data recorded on the card. This ensures that the encryption proof comes from an electronic card, after successful biometric identification. In addition, this encryption mode guarantees the confidentiality of the vote since the decryption key associated with the homomorphic encryption is not public.

At a step 250, the voting method includes the voter signing his encrypted vote c, to obtain a signed vote σ. The signature depends on the voter's private key usk_{id} and the encrypted vote c.

In the present example, the signature is obtained by a Schnorr digital signature algorithm. The signature then depends on the private key usk_{id}, but also on the public key upk_{id}.

In addition, the signature uses a random number obtained by a hazard generator on the smart card Eₘ with each new signature. The signature can include a number of the form g^{w} with w as a random integer. This number may have been pre-calculated prior to the signature.

The validity of the signature can later be verified by the voting terminal and/or during the counting, using the voter's public key upk_{id}, without requiring knowledge of the private key usk_{id}.

Such a signature has several advantages. It ensures that the vote has not been altered after the voter has selected the voting option. It also guarantees the identity of the voter and allows to verify that only one vote has been submitted per authorized voter, to avoid a ballot box jam.

Reference can be made to section 4.11 of the Belenios specification document: http://www.belenios.org/specification.pdf for an algorithm for calculating the signature and subsequent verification of the validity of the signature.

The voting option v is transmitted to the card Eₘ at the end of step 230 and the encryption 240 and signature 250 steps are performed inside the smart card Eₘ.

An advantage of encrypting and signing votes inside the smart card is to increase the security of the voting method against potential external attacks. The smart card is more resistant to hacking than a server connected to the network.

In particular, assuming that the smart card is resistant to external attacks, the voter cannot have access to the intermediate encryption and signature data of his or her own vote. Therefore, the voting method has a receipt-freeness property.

At the end of step 250, a complete ballot B has been constructed from the voting option submitted by the voter.

In this example, the ballot is in the form, B=(upk_{id}, c, σ).

Ballot B is centralized by the voting terminal S for sending to administration server A.

Optionally, the voting terminal S implements a ballot verification before transmitting the ballot. The voting terminal S verifies the validity of the signed vote σ using the voter's public key upk_{id}, preferably according to a zero knowledge proof algorithm.

Terminal S also checks the validity of the encrypted vote c. It is verified without decryption that the encrypted vote corresponds to the encryption of a valid vote.

If the above verifications are positive, bulletin B is sent to a server for processing.

### Counting of Votes

The counting of votes can be done by the certification servers CSⱼ. Each server has a secret key skⱼ to obtain the voting options selected by the participants in the poll from the encrypted votes c present in the ballots B considered valid.

Server A of administrations performs a sum of the encrypted votes.

Each certification server CSⱼ calculates a partial decryption of said sum. Finally, server A combines the partial decryptions to obtain the decryption of the sum of the encrypted votes.

The complete decryption of the voting options chosen by the voters therefore requires a cooperation of all servers CSⱼ.

The administration server then generates a total voting result, for example a distribution of votes among the various candidates, after an eventual check of decryption evidence generated by the servers CSⱼ.

Since the encryption of voting options is homomorphic, the servers that perform the counting can obtain the decrypted voting result, without having the individual decrypted votes.

Alternatively, the analysis can be performed by a single server, for example administration server A.

Advantageously, when the total voting result is published, a list containing hashes of ballots is also made public. Each voter may take with him/her the printed identifier that he/she has collected from the voting terminal during the voting. This printed identifier shows a hash uniquely associated with the ballot B when generating the ballot B. The voter can check that the hash is in the list, to ensure that his vote has been taken into account in the total result.

1. A method of enrolling voters for an election, the method being implemented by an electronic device (Eₘ),
the method comprising the steps of:
receiving (130) a plurality of biometric data (t) acquired on a plurality of voters,
associating (140), in a memory of the electronic device, each biometric data (t) with at least one voting cryptographic data (CD) or with a pointer corresponding to a voting cryptographic data,
so that later, during the voting, each voter can be biometrically identified using the electronic device and vote with the voting cryptographic data (CD) associated with the biometric data acquired on the said voter.

2. A method of enrolling according to claim 1, wherein each of the biometric data received is associated with cryptographic voting data of a single voter in the memory.

3. A method of enrolling according to claim 1, comprising an additional step of generating (120a) voting cryptographic data (CD) by the electronic device.

4. A method of enrolling according to claim 1, comprising receiving the cryptographic data (CD).

5. A method of enrolling according to claim 1, wherein the biometric data (t) is associated in the memory with a pointer (P_{CD}) corresponding to the voting cryptographic data and said cryptographic data (CD) is recorded in a remote database.

6. A method of enrolling according to claim 1, wherein the cryptographic voting data include a voter private key usk_{id} and a voter public key upk_{id}, preferably in the form, upk_{id}=g^{uskid} mod p with p and g domain parameters.

7. A method of enrolling according to claim 1, comprising a prior association step, in a database of a remote server, between an identifier of a voter of the plurality of voters and a polling station identifier, the electronic device being located in a polling station corresponding to said polling station identifier during the poll.

8. An electronic voting method comprising implementing a method of enrolling according to claim 1,
the voting method further comprising the following steps implemented by the electronic device (Eₘ) during the voting:
receiving (210) a biometric data (b) acquired by a biometric sensor (BS) on an individual, said biometric data (b) corresponding to a type of biometric data used for enrollment,
verifying (220) a match between the acquired biometric data and a biometric data (t) stored in the memory of the electronic device,
if said verification is positive, transmission of a voting result generated using voting cryptographic data (CD).

9. A voting method according to claim 8, wherein, to generate the voting result, the electronic device transmits to a remote server a pointer (Pco) corresponding to a voting cryptographic data, and receives from said remote server the voting cryptographic data (CD),
the cryptographic data being preferably encrypted with an encryption key (K) of the electronic device.

10. A voting method according to claim 8, comprising further steps of entering (230) a voting option (v) by the individual and of encrypting (240) the voting option using a voting key (pk) to obtain an encrypted vote (c) included in the voting result.

11. A voting method according to claim 10, wherein the encryption step (240) further comprises generating a proof of voting validity using the cryptographic data (CD), preferably using a voter secret key (usk_{id}) included in the cryptographic data.

12. A voting method according to claim 8, wherein the verification step includes searching for a match between the biometric data acquired by the sensor and the plurality of biometric data stored at enrollment, preferably by a Nearest Neighbour Search method

13. An electronic device (Eₘ) comprising a secure element for implementing a method of enrolling a voter and for implementing a voting method according to claim 8, said secure element having a memory configured to store a plurality of associations between at least one cryptographic voting data (CD) and a biometric data (t),
said electronic device being configured to verify a match between one of the stored biometric data (t) and an acquired biometric data of the same type as the stored biometric data (t).

14. An electronic device according to claim 13, the electronic device being a smart card or USB key or a secure mobile device.

15. Voting device intended to be installed in a polling station and comprising:
an electronic device (Eₘ) according to claim 13,
a biometric sensor (BS),
a voting terminal (S) including a user interface.
